(19) United States
(12) Patent Application Publication
(10) Pub. No.: US 2006/0134589 A1
(43) Pub. Date: Jun. 22, 2006

(54) System, method, and apparatus for restorative activity board

(76) Inventor: Rose E. Goodwin, Tucson, AZ (US)

Correspondence Address: Rose E. Goodwin, # Z, 3200 S. Mann Ave, Tucson, AZ, 85730, US

(21) Appl. No.: 11/319,155

(22) Filed: Dec. 28, 2005

Related U.S. Application Data
(63) Continuation-in-part of application No. 10/280,983, filed on Oct. 28, 2002.

(51) Int. Cl. G09B 19/00

(52) U.S. Cl. 434/259

(57) ABSTRACT

A system for restorative therapeutic activity is disclosed including a first activity board with a front panel including a plurality of peg holes disposed into patterns, and a second activity board with also with a front panel including a plurality of peg holes disposed into patterns. The first activity board may be located at a clinical location while the second activity board may be located at a home location, allowing a patient to perform restorative therapeutic activity in a plurality of disparate locations. A method of restoring activity is also disclosed including utilizing a first activity panel at a first location and a second activity panel at a second location.

### REFERENCE TO RELATED APPLICATION

This application is a continuation-in-part of U.S. patent application Ser. No. 10/280,983.

### FIELD OF THE INVENTION

The present invention relates in general to graded activity boards and, more particularly, to a system, method, and apparatus for restoring upper extremity reaching.

### BACKGROUND OF THE INVENTION

The existing innovation corresponds to Graded Activity boards, principally, activity boards that offer a range of graded dowels for the purpose of upper extremity reaching. Activity boards are suited for neurological disorders, CVA, head trauma, upper extremity injury and lower extremity injury (upper extremity reaching effects the lower part of the body).

Hospitals, acute care and medical centers use a wide variety of treatment tools for neurological hand deficits, in particular, deficits caused by stroke. These facilities habitually use a task oriented approach. This means they use activities of daily living as in grooming, feeding and dressing activities relating to daily living skills. These common modes of therapy have not been effective in rehabilitating neurological upper extremity insults because they are not repetitive in nature and do not tackle the core issue of neurological difficulty, which is resistant to half measures and demands repetitive training that is able to induce motor performance.

The challenge concerning all neurological injuries, especially, in the early stages of the insult is the introduction of sensorimotor training in the form of reach training. Repetitive execution of identical movements has been demonstrated to be crucial for recovery of hand/digit/arm function in a stroke/neurological patient.

Currently, in the medical market there are few effective tools that address upper extremity paralysis and essentially no therapies utilizing a system of multiple activity boards that allow the patient to practice at home the same therapy used in a clinical environment.

Moreover, medical facilities with time restraints limit the kind and amount of therapy given. The usual regime of inpatient care involves basic training in preparation for safety at home. Take home plans in general often involve an extension of inpatient goals which include activities of daily living or ADL's. This type of home therapy is insufficient for even marginal hand return and does not address depression caused by trauma. For the most part recovery is left up to the patient.

The patient simply does not know what to do after discharge. Trauma and depression leave this population with low motivation. Providing the patient solutions prior to leaving the clinic, offers the only hope, the patient must be able to return daily to a concrete solution designed by the brain. This in time (weeks/months) can induce long lasting permanent changes in chronic upper extremity paresis.

As explained earlier, the medical market has few effective therapies to challenge the return of neurological hand deficits, with the exception of a therapy called constraint therapy (CT).

CT involves restraint of the affected hand behind the patients back for a period of fourteen days. The patient must perform activities using the injured hand. This kind of therapy may suggest how very resistant neurological injuries can be. A select few have access to this plan, as it is offered only in a clinical setting, located in the mid west and involves a long waiting period.

One therapeutic method includes the use of pegboards. Pegboards on the market are simple pegboards with simple instructions for use with fine motor skills. However, traditional pegboard systems do not symbolize a concept of recovery with regard to patient/therapist relationship nor suggests recovery with multiple pegboards or therapies.

Accordingly, there is a desperate need, for in-clinic therapy tools that induce long lasting permanent changes in chronic upper extremity paralysis and for discharge plans that follow. Additionally, there is a need for home-therapy tools that allow the patient to continue therapy at home, thus increasing the therapeutic effects of the therapy and shortening the recovery time. There is no greater motivation for the therapist in work place than to use a reliable therapy that will follow the patient home at discharge.

### SUMMARY OF INVENTION

A system of multiple activity boards offers patient/therapist motivation utilizing a therapeutic restorative system which includes at least two activity boards. Each activity board includes a stand up, two panel, A-frame table-top pegboard configuration, and tube like circles and dowels of varying sizes.

In another embodiment of the invention, a method includes the therapist utilizing a first activity board in a clinical setting and the patient using another potentially smaller take-home board at home. The therapist models clinical base instruction using the first activity board and than sends the patient home with the take-home board to practice the same therapy. One justification for a multiple board system is to promote home programs in order for the patient to achieve full hand return in a shorter period of time.

The system of multiple activity boards is actually the first mode of physical structure in the medical market that offers a concept of healing using a system of like boards to induce motor function through repetitive movements and at the same time promote patient/therapist motivation.

### BRIEF DESCRIPTION OF DRAWINGS

FIG. 1 is a front perspective view of a system of multiple activity boards, according to the invention.

FIG. 2 is a rear perspective view of the system of multiple activity boards of FIG. 1.

FIG. 3 further illustrates the system of multiple activity boards of FIG. 1 including sets of graded tubes, according to the invention.

FIG. 4 further illustrates the system of multiple activity boards of FIG. 1 including sets of dowels, according to the invention.

### DETAILED DESCRIPTION OF THE INVENTION

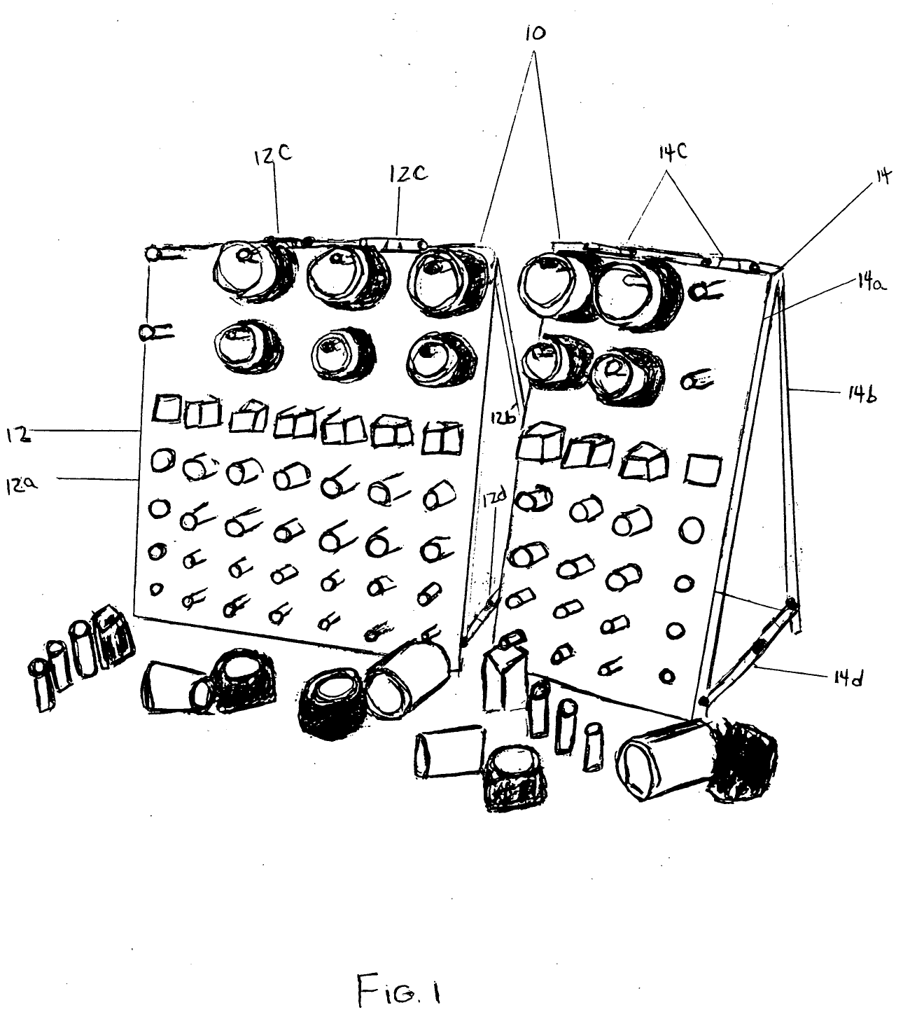

FIG. 1 illustrates a restorative activity system 10 including a clinic-use activity board 12 and a home-use activity board 14. The terms clinic-use activity board and home-use activity board are used to indicate that more than one activity board is necessary to properly utilize the restorative activity system 10 and are not terms of limitation. The clinic-use activity board 12 may be used in a clinical environment, at a patient's home, or any other location that is convenient for the patient or the therapist. Likewise, the home-use activity board 14 may be used in a home environment, in a clinical environment, or any other location that is convenient for the patient or the therapist. Each activity board 12,14 may be located at disparate physical locations or may be simultaneously utilized in a common locale. Additionally, two or more activity boards 12,14 may be combined to create a unified activity board.

Each activity board 12,14 includes a front panel 12a,14a, a back panel 12b,14b, and one or more hinges 12c,14c. In one embodiment of the invention, two or more activity boards 12,14 may be joined together using a folding table hinge 12d,14d or similar connecting device into a unified unit.

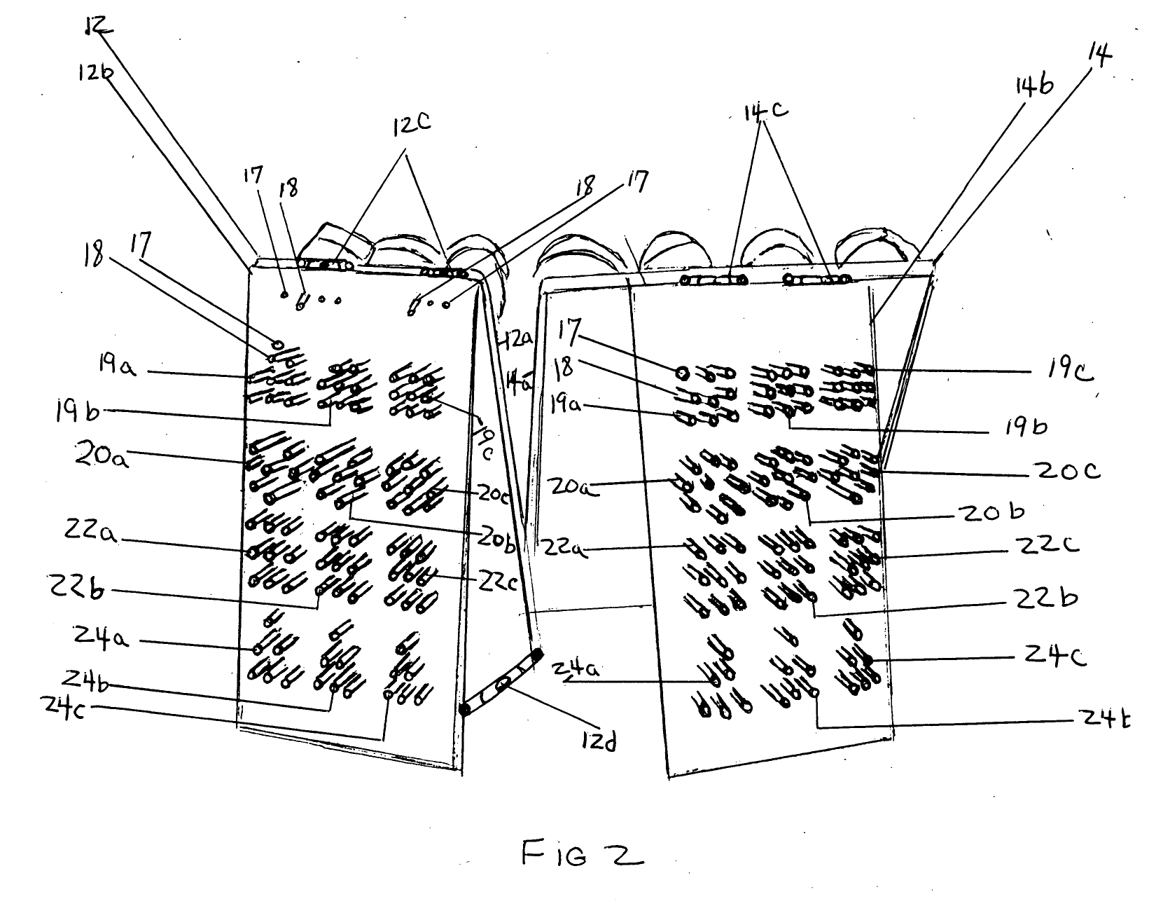

FIG. 2 more fully illustrates the back panels 12b,14b of the clinic-use activity board 12 and the home-use activity board 14. The hinges 12c,14c allow the front panels 12a,14a and the back panels 12b,14b to be adjusted relative to each other. In the illustration of FIGS. 1 and 2, the front panels 12a,14a and the back panels 12b,14b are positioned so that each activity board 12,14 forms an A-frame shape, allowing it to stand upright on a table or other similar approximately flat surface.

The panels 12a,12b,14a,14b of FIGS. 1 and 2 include peg holes 17 optionally forming geometric patterns. Removable dowels 18 may be inserted into the holes by a patient or grasped and removed by the patient. In the illustration of FIG. 2, several dowels 17 are inserted into peg hole 18 configured into squares 19a, 19b, 19c. In this embodiment of the invention, the leftmost square 19a is larger than the middle square 19b which is, in turn, larger than the rightmost square 19c. Alternatively, the rightmost square 19c may be larger than the middle square 19b which is, in turn, larger than the leftmost square 19a.

Additionally, several dowels 17 are inserted into peg holes 18 configured into circles 20a, 20b, 20c. In this embodiment of the invention, the leftmost circle 20a is larger than the middle circle 20b which is, in turn, larger than the rightmost circle 20c.

FIG. 2 also shows several dowels 17 inserted into peg holes 18 configured into rectangles 22a, 22b, 22c. The leftmost rectangle 22a is larger than the middle rectangle 22b which is, in turn, larger than the rightmost rectangle 22c.

Another optional element of the invention is illustrated by the bottom row of geometric shapes disposed on the back panel 12b,14b of the activity boards 12,14. Here, several dowels 17 are inserted into peg holes 18 configured into triangles 24a, 24b, 24c. The leftmost triangle4 24a is larger than the middle triangle 24b which is, in turn, larger than the rightmost triangle 24c.

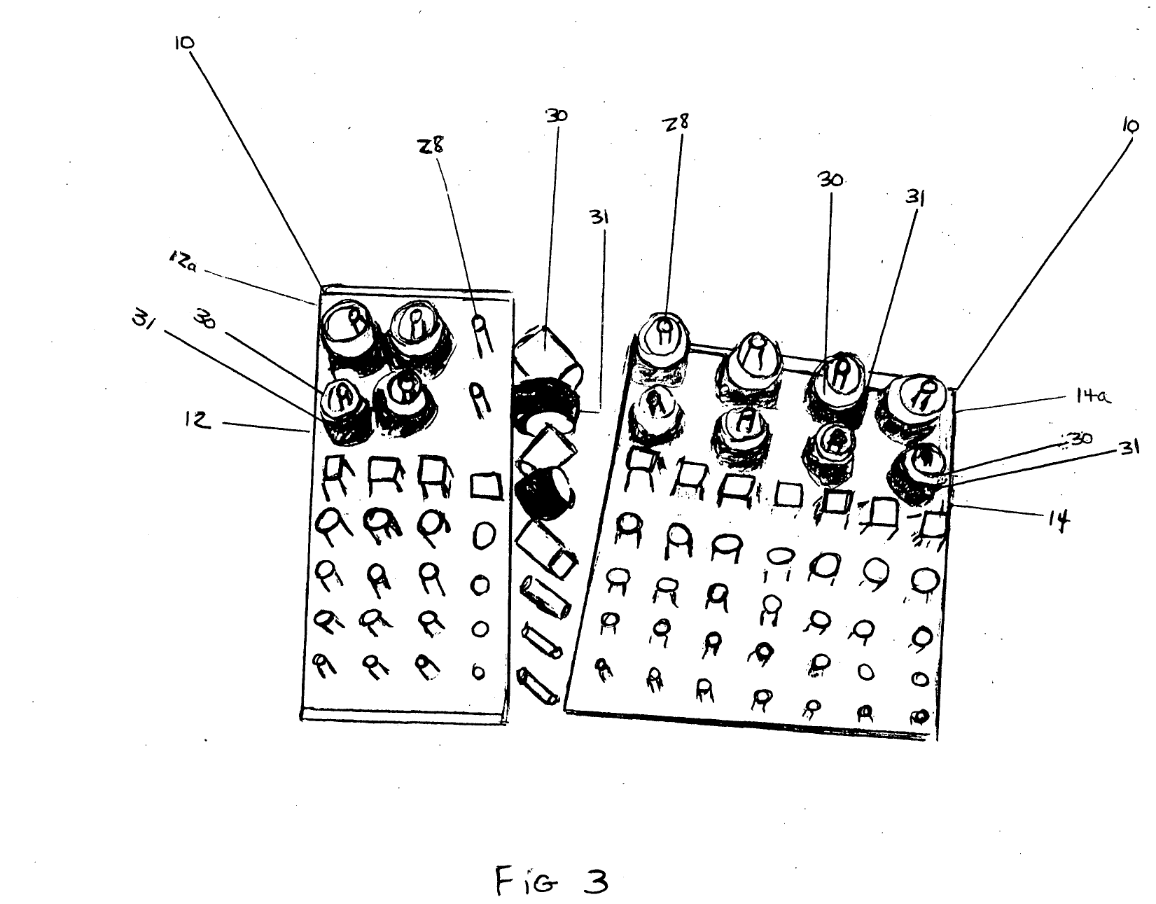

FIG. 3 displays the front panels 12a,14a of alternate embodiments of activity boards 12,14, including one or more rows of circular pegs 30,31 which may be placed over one or more pegs 28. To distinguish different sizes and shapes of circular pegs, different colors may be applied to the circular pegs 30,31. For example, the smaller circular pegs 30 may be colored white while the larger circular pegs may be colored black. In this embodiment of the invention, the circles as slightly graded permitting the larger circles 31 to slide over the smaller circles 30.

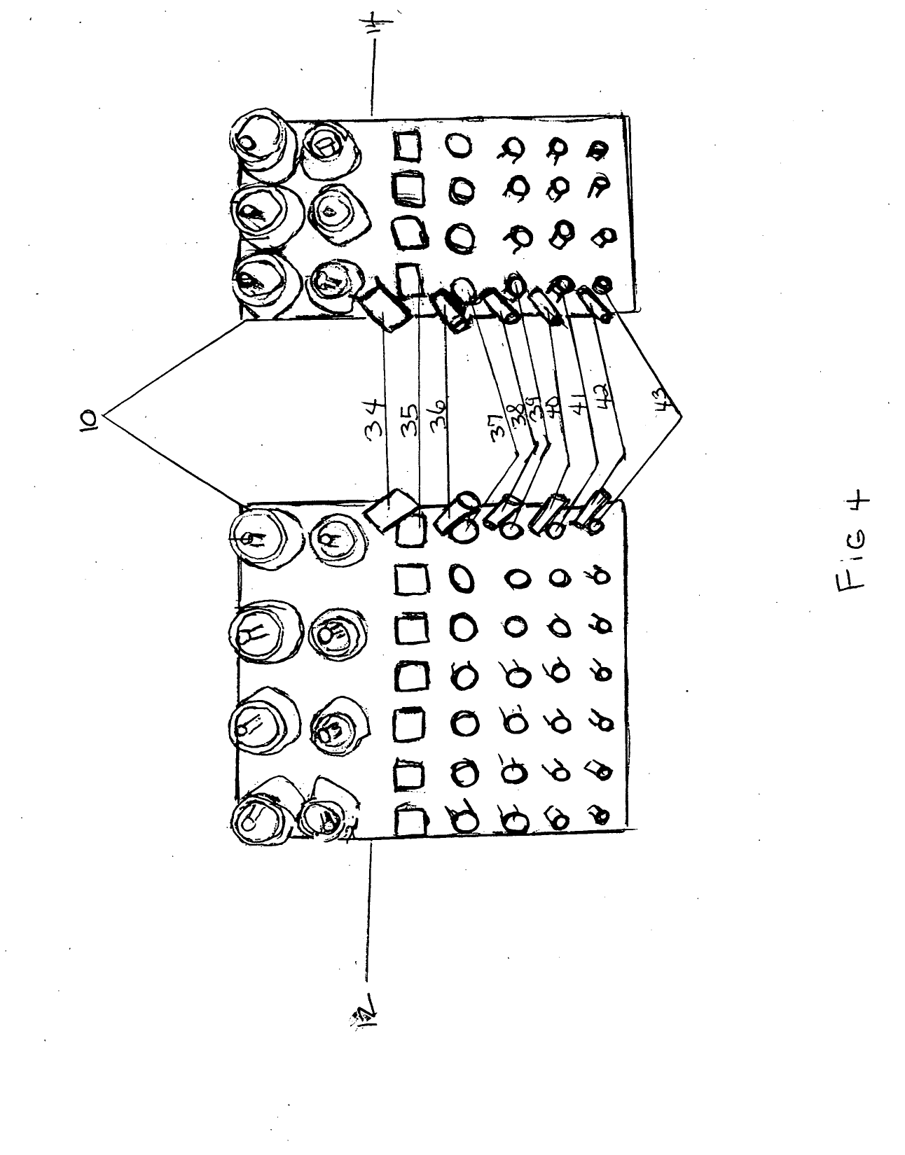

FIG. 4 displays activity boards 12,14 with a sequence of graded peg holes with their corresponding graded dowels. A square dowel 34 is provided for the square peg holes 35. A round dowel 36 is provided for the round peg holes 37 and begins a sequence of four rows of graded reaches. As illustrated 39 peg hole provided for dowel 38, 41 peg hole provided for dowel 40, 43 peg hole provides for dowel 42.

While one or more embodiments of the present invention have been illustrated in detail, the skilled artisan will appreciate that modifications and adaptations to those embodiments may be made without departing from the scope of the present invention as set forth in the following claims.

What is claimed is:

1. A method of restoring activity to a patient, comprising:
configuring a first front activity panel of a first activity board with a first plurality of pegholes disposed into a first plurality of patterns;
configuring a second front activity panel of a second activity board with a second plurality of peg holes disposed into a second plurality of patterns;
inserting a first plurality of dowels into the first plurality of peg holes, wherein the first activity board is located at a first location; and
inserting a second plurality of dowels into the second plurality of peg holes, wherein the second activity board is located at a second location.

2. The method of claim 1, wherein the first location is a clinical environment.

3. The method of claim 1, wherein the second location is a home environment.

4. The method of claim 1, wherein the first and second locations are a common location.

5. The method of claim 1, wherein the first plurality of patterns comprises a plurality of geometric shapes.

6. The method of claim 5, wherein the plurality of geometric shapes includes a plurality of like shapes.

7. The method of claim 6, wherein the plurality of like shapes are disposed on the first activity board in a descending manner with the leftmost like shape smaller than the rightmost like shape.

8. The method of claim 6, wherein the plurality of like shapes comprises squares.

9. The method of claim 6, wherein the plurality of like shapes comprises circles.

10. The method of claim 6, wherein the plurality of like shapes comprises triangles.

11. In a system for restorative activity, comprising:
a first activity board comprising a first front activity panel comprising a first plurality of peg holes disposed into a first plurality of patterns;
a second activity board comprising a second front activity panel comprising a second plurality of peg holes disposed into a second plurality of patterns;
a first plurality of dowels for insertion into the first plurality of peg holes; and
a first plurality of dowels for insertion into the first plurality of peg holes.

12. The system of claim 11, wherein the first activity board is removably coupled to the second activity board.

13. The system of claim 11, wherein the first activity board is located at a first location and the second activity board is located at a second location.

14. The system of claim 11, wherein the first plurality of patterns comprises a plurality of geometric shapes.

15. The system of claim 14, wherein the plurality of geometric shapes includes a plurality of like shapes.

16. The system of claim 15, wherein the plurality of like shapes comprises squares.

17. The system of claim 15, wherein the plurality of like shapes comprises circles.

18. A method of restoring activity to a patient, comprising:
configuring a first front activity panel of a first activity board with a first plurality of pegs, wherein the first activity board is located at a first location;
configuring a second front activity panel of a second activity board with a second plurality of pegs, wherein the second activity board is located at a second location; and
placing a first graded shape over one of the first plurality of pegs.

19. The method of claim 18, further comprising placing a second graded shape over the first graded shape.

20. The method of claim 18, wherein the first location and second location are a common location.
